(19) United States
(12) Patent Application Publication
(10) Pub. No.: US 2026/0226259 A1
(43) Pub. Date: Aug. 6, 2026

(54) RECYCLED POLYETHYLENE COMPOSITIONS WITH GOOD THERMO-PHOTO STABILITY

(71) Applicant: Borealis GMBH, Vienna (AT)

(72) Inventors: Yi Liu, Linz (AT); Jingbo Wang, Linz (AT); Claudia Kniesel, Linz (AT); Konrad Gerbauer, Leipzig (DE)

(21) Appl. No.: 19/149,215

(22) PCT Filed: Jan. 24, 2024
(86) PCT No.: PCT/EP2024/051613

§ 371 Date: Jul. 18, 2025

(30) Foreign Application Priority Data
Jan. 24, 2023 (EP) 23153041.1

(51) Int. Cl. C08L 23/06; C08J 3/20; C08K 5/134; C08K 5/3492; C08K 5/524

(52) U.S. Cl. CPC C08L 23/06; C08J 3/201; C08K 5/1345; C08K 5/34926; C08K 5/524; C08J 2323/06; C08J 2423/06; C08L 2201/08; C08L 2203/202; C08L 2205/025; C08L 2207/062; C08L 2207/066; C08L 2207/20

(57) ABSTRACT

The present invention relates to a mixed-plastic recyclate polyethylene composition having a melt flow rate (ISO 1133, 2.16 kg, 190° C.) of from 0.1 to 1.2 g/10 min; and a density of from 930 to 955 kg/m3, and comprising 35 wt.-% or more of a recycled low density polyethylene fraction (A) having a crystallization temperature of not lower than 106° C.; at least one HALS UV stabilizer; at least one metal deactivator; a first virgin high density polyethylene component (B) and optionally a second virgin high density polyethylene component (C), optionally blended with carbon black or other pigments, wherein the mixed-plastic recyclate polyethylene composition has a tensile strain at break, determined according to ISO 527-1 on compression moulded ISO 527-2/5A specimens, after weather ageing of 2000 h according to EN ISO 4892-2, of at least 500%. The invention also relates to a method of preparing such a mixed-plastic recyclate polyethylene composition, to an article made from such a mixed-plastic recyclate polyethylene composition, especially a jacketing material of a power cable, and to the use of such a mixed-plastic recyclate polyethylene composition for wire and cable applications.

### FIELD OF THE INVENTION

The present invention related to a mixed-plastic recyclate polyethylene composition having excellent thermo-photo stability, to a method of preparing the same, to articles made of the same and to its use for wire and cable applications.

### BACKGROUND OF THE INVENTION

Polyolefins, in particular polyethylene and polypropylene are increasingly consumed in large amounts in a wide range of applications, including packaging for food and other goods, fibres, automotive components, wires and cables, and a great variety of manufactured articles.

Taking into account the huge amount of waste collected compared to the amount of waste recycled back into the stream, there is still a great potential for intelligent reuse of plastic waste streams and for mechanical recycling of plastic wastes.

Generally, recycled quantities of polyethylene on the market are mixtures of both polypropylene (PP) and polyethylene (PE), this is especially true for post-consumer waste streams. Moreover, commercial recyclates from post-consumer waste sources (PCR) are conventionally cross contaminated with non-polyolefin materials, such as polyethylene terephthalate, polyamide, polystyrene or non polymeric substances like wood, paper, glass or aluminum. These cross-contaminations drastically limit final applications or recycling streams such that no profitable final uses remain.

In addition, recycled polyolefin materials normally have properties, which are much worse than those of the virgin materials, unless the amount of recycled polyolefin added to the final compound is extremely low. For example, such materials often have limited impact strength and poor mechanical properties (such as e.g. brittleness) and thus, they do not fulfil customer requirements. This particularly applies in applications, such as jacketing materials (for cables), containers, automotive components or household articles. This normally excludes the application of recycled materials for high quality parts, and means that they are only used in low-cost, non demanding applications, such as e.g. in construction or in furniture. In order to improve the mechanical properties of these recycled materials, generally relatively large amounts of compatibilizing/coupling agents and elastomeric polymers are added. These materials are generally virgin materials, which are produced from oil.

Another particular problem in recycled polyolefin, e.g. polyethylene materials is that variations in ESCR (Environmental Stress Crack Resistance) properties can also be observed in recycled polyethylene blends depending on the waste origin. Thus, there is need for addressing these limitations in a flexible way. For jacketing applications generally an ESCR (Bell test failure time) of greater than 1000 hours is desirable.

Thus, there remains a strong need in the art to provide recycled polyethylene solutions for wire and cable applications, especially for wire and cable applications that have acceptable and constant mechanical properties which are similar to blends of virgin polyethylene marketed for wire and cable applications. It is also desirable to maximize the loading of recycled polyethylene material.

Recycled polymers are contaminated by both organic and inorganic substances. These contaminations can reduce or eliminate the effectiveness of certain additives added to the recyclate-containing composition for enhanced properties. For examples unwanted polyolefins, other polymers, unwanted metals, and functional groups are introduced in the course of the recycling process. In particular, metals such as Co, Fe, Cu, Mo, Ti, Zn, are reported in literature to deteriorate thermo-photo stability (e.g. Journal of Vinyl and Additive Technology 17, 21-27, (2011); Polymer Degradation and Stability 53, 79-87, (1996); Polymer Degradation and Stability 84, 7-11, (2004)).

Stabilization packages comprising phenolic and phosphorous antioxidants, calcium stearate, HALS and metal deactivator are known in polyolefin recyclate compositions. The presence of metal deactivator is found to greatly improve thermo-photo stability.

For example, EP 0 565 868 A2 discloses a polyolefin composition having improved oxidative stability, the stabilized composition comprising an ethylene homopolymer or copolymer containing (a) a divalent metal-containing hindered phenolic compound and (b) a metal deactivator having one or more hindered phenol groups linked to a hydrazo or oxamido group. The stabilized polyolefin composition is useful in the insulation of wire and cable and are characterized by increased resistance to oxidation.

WO 2000/058975 A1 discloses stabilized cable construction, which comprises (i) a plurality of insulated electrical conductors having interstices there between, said insulation comprising (a) one or more polyolefins, and (b) one or more primary antioxidants, and (c) one or more metal deactivators selected from the alkyl hydroxyphenylalkanoyl hydrazines, and (ii) hydrocarbon cable filler grease within the interstices, and (iii) a sheath surrounding components (i) and (ii). The stabilized cable construction provides oxidative stability for polyolefin wire insulation, e.g. telecommunication cables.

CN 112745547 A discloses thermal-oxidative-aging-resistant regenerated polyethylene material comprising a regenerated high-density polyethylene, a regenerated low-density polyethylene, a carbon black master batch, a compatilizer, a first lubricant and a composite antioxidant master batch. The composite antioxidant master batch comprises polyethylene, an antioxidant, a metal deactivator, which is N,N′-bis[3-(3,5-ditert.-butyl-4-hydroxyphenyl) propionyl] hydrazine, a nucleating agent and a second lubricant.

In recyclates, various metals, in varying oxidative states, different compounds and different mineral forms are mixed. Their effects on polymer degradation are complex and rarely studied. These metal contaminants may further influence or degrade other additives in the recyclate which thus have reduced benefits or lose their activity.

Therefore, it is an object of the present invention to provide an improved recyclate polyethylene composition having excellent thermo-photo stability, weather resistance and flame retardance, even in the presence of metal contaminations.

### SUMMARY OF THE INVENTION

Thus, the inventors have found a new mixed-plastic recyclate polyethylene composition having a melt flow rate (ISO 1133, 2.16 kg, 190° C.) of from 0.1 to 1.2 g/10 min; and a density of from 930 to 955 kg/m³, and comprising
50 wt.-% or more of a recycled low density polyethylene fraction (A) having a crystallization temperature of not less than 106° C.;
at least one HALS UV stabilizer;
at least one metal deactivator;
wherein the mixed-plastic recyclate polyethylene composition has a tensile strain at break, determined according to ISO 527-1 on compression moulded ISO 527-2/5A specimens, after weather ageing of 2000 h according to EN ISO 4892-2 and as described in the experimental section below, of at least 500%.

The mixed-plastic recyclate polyethylene composition according to the present invention comprises a first virgin high density polyethylene component (B) and optionally a second virgin high density polyethylene component (C), optionally blended with carbon black. or other pigments, e.g., inorganic pigments that include iron oxide, titanium dioxide, zinc ferrite yellow, bismuth vanadate, mixed metal oxides, etc. and organic pigments that include quinacridones, benzimidazolone, isoindolinone, perylene, Cu-phthalocyanine, etc. The above object can also be achieved by a method of preparing the above mixed-plastic recyclate polyethylene composition of the invention, comprising the step of melt mixing and extruding the recycled polyethylene fraction (A) in the presence of the at least one HALS UV stabilizer, and the at least one metal deactivator and in the presence of the first virgin high density polyethylene component (B) and/or the second virgin high density polyethylene component (C) in an extruder.

The above object can further be achieved by an article made from the mixed-plastic recyclate polyethylene composition according to the present invention, whereby said mixed-plastic recyclate polyethylene composition amounts to at least 85 wt.-% of the total composition for making the article. The article preferably is a jacketing material of a power cable.

The above object can further be achieved by the use of the mixed-plastic recyclate polyethylene composition according to the present invention for wire and cable applications.

### DETAILED DESCRIPTION OF THE PRESENT INVENTION

For the purposes of the present description and of the subsequent claims, the term “recycled waste” is used to indicate a material recovered from post-consumer waste, as opposed to virgin polymers and/or materials. Post-consumer waste refers to objects having completed at least a first use cycle (or life cycle), i.e. having already served their first purpose.

The term “virgin” denotes newly produced polymeric materials and/or objects prior to their first use, which have not already been recycled. The term “recycled material” such as used herein denotes materials reprocessed from “recycled waste”.

The term “natural” in the context of the present invention means that the components are of natural colour. This means that no pigments (including carbon black) are included in the components of such a component.

A blend denotes a mixture of two or more components, wherein at least one of the components is polymeric. In general, the blend can be prepared by mixing the two or more components. Suitable mixing procedures are known in the art. The virgin high density polyethylene component (B) and/or (C) may be a reactor made high density polyethylene material. Said high density polyethylene material may contain carbon black or any other pigments. However, carbon black or any other pigments may also be absent. The virgin high density polyethylene material is a virgin material which has not already been recycled.

### Mixed-Plastic Recyclate Polyethylene Composition

For the purposes of the present description and of the subsequent claims, the term “mixed-plastic recyclate polyethylene composition” indicates a polymer material including predominantly units derived from ethylene apart from other polymeric ingredients of arbitrary nature. Such polymeric ingredients may for example originate from monomer units derived from alpha olefins such as propylene, butylene, octene, and the like, styrene derivatives such as vinylstyrene, substituted and unsubstituted acrylates, substituted and unsubstituted methacrylates. Said polymeric materials can be identified in the mixed-plastic recyclate polyethylene composition by means of quantitative ¹³C{¹H} NMR measurements as described herein. In the quantitative ¹³C{¹H} NMR measurement used herein and described below in the measurement methods different units in the polymeric chain can be distinguished and quantified. These units are ethylene units (C2 units), units having 3, 4 and 6 carbons and units having 7 carbon atoms.

Thereby, the units having 3 carbon atoms (C3 units) can be distinguished in the NMR spectrum as isolated C3 units (isolated C3 units) and as continuous C3 units (continuous C3 units) which indicate that the polymeric material contains a propylene based polymer. These continuous C3 units can also be identified as PP units. The continuous C3 units thereby can be distinctively attributed to the recycled low density polyethylene fraction (A) as the virgin high density polyethylene component (B) and/or (C) in the mixed-plastic recyclate polyethylene composition according to the present invention usually does not include any propylene based polymeric components.

The units having 3, 4, 6 and 7 carbon atoms describe units in the NMR spectrum which are derived from two carbon atoms in the main chain of the polymer and a short side chain or branch of 1 carbon atom (isolated C3 unit), 2 carbon atoms (C4 units), 4 carbon atoms (C6 units) or 5 carbon atoms (C7 units).

The units having 3, 4 and 6 carbon atoms (isolated C3, C4 and C6 units) can derive either from incorporated comonomers (propylene, 1-butene and 1-hexene comonomers) or from short chain branches formed by radical polymerization.

The units having 7 carbon atoms (C7 units) can be distinctively attributed to the recycled low density polyethylene fraction (A) as they cannot be derived from any comonomers. 1-heptene monomers are not used in copolymerization. Instead, the C7 units represent presence of LDPE distinct for the recyclate. It has been found that in LDPE resins the amount of C7 units is always in a distinct range. Thus, the amount of C7 units measured by quantitative ¹³C{¹H} NMR measurements can be used to calculate the amount of LDPE in a polyethylene composition. Thus, the amounts of continuous C3 units, isolated C3 units, C4 units, C6 units and C7 units are measured by quantitative ¹³C{¹H} NMR measurements as described below, whereas the LDPE content is calculated from the amount of C7 units as described below.

The total amount of ethylene units (C2 units) is attributed to units in the polymer chain, which do not have short side chains of 1-5 carbon atoms, in addition to the units attributed to the LDPE (i.e. units which have longer side chains branches of 6 or more carbon atoms).

The mixed-plastic recyclate polyethylene composition of the present invention has a tensile strain at break, determined according to ISO 527-1 on compression moulded ISO 527-2/5A specimens, after weather ageing of 2000 h according to EN ISO 4892-2 and as described herein, of at least 500%, preferably at least 520%, more preferably at least 530%, even more preferably at least 550%.

The mixed-plastic recyclate polyethylene composition of the present invention preferably has an oxidation induction time (OIT) at 200° C., determined as described in the experimental section below, of not less than 50 min., more preferably not less than 60 min.

### Recycled Low Density Polyethylene Fraction (A)

A recycled low density polyethylene fraction (A) denotes the starting primary blend containing the mixed plastic-polyethylene as described above. Conventionally further components such as fillers, including organic and inorganic fillers for example talc, chalk, carbon black, and further pigments such as TiO₂ as well as paper and cellulose may be present. In a specific and preferred embodiment the waste stream is a consumer waste stream, such a waste stream may originate from conventional collecting systems such as those implemented in the European Union. Post-consumer waste material is characterized by a limonene content of from 0.1 to 500 mg/kg (as determined using solid phase microextraction (HS-SPME-GC-MS) by standard addition).

A recycled low density polyethylene fraction (A) as used herein is commercially available. One suitable recyclate is e.g. available from Ecoplast Kunststoffrecycling GmbH.

One component of the mixed-plastic recyclate polyethylene composition according to the present invention is a fraction (A) of a recycled low density polyethylene having a crystallization temperature of not less than 106° C., preferably not less than 107° C., more preferably not less than 108° C.

The recycled low density polyethylene fraction (A) is contained in the mixed-plastic recyclate polyethylene composition according to the present invention in an amount of at least 35 wt.-%, preferably at least 40 wt.-%, more preferably at least 48 wt.-%, with respect to the total amount of the mixed-plastic recyclate polyethylene composition.

Preferably, at least 90 wt.-%, more preferably at least 95 wt.-%, even more preferably 100 wt.-% of the recycled low density polyethylene fraction (A) originates from post-consumer waste and/or post-industrial waste having a melt flow rate (ISO 1133, 2.16 kg, 190° C.) of preferably from 0.1 to 1.5 g/10 min, more preferably from 0.3 to 1.4 g/10 min, a density of preferably from 910 to 945 kg/m³, more preferably from 915 to 942 kg/m³, even more preferably from 920 to 940 kg/m³, and a total amount of ethylene units (C2 units) of preferably from 80.00 to 96.00 wt.-%, more preferably from 82.50 to 95.50 wt.-%, even more preferably of from 85.00 to 95.50 wt.-%, still more preferably of from 87.50 to 95.00 wt.-%, with the total amounts of C2 units being based on the total weight amount of monomer units in the recycled low density polyethylene fraction (A) and measured according to quantitative ¹³C{¹H} NMR measurement, as described in the experimental section below.

The recycled low density polyethylene fraction (A) may preferably comprise a total amount of continuous units having 3 carbon atoms corresponding to polypropylene (continuous C3 units) of from 0.20 to 6.50 wt.-%, more preferably from 0.40 to 6.00 wt.-%, still more preferably from 0.60 to 5.50 wt.-% and even more preferably from 0.75 to 5.00 wt.-%. The total amounts of C2 units and continuous C3 units thereby are based on the total weight amount of monomer units in the mixed-plastic-polyethylene primary recycling blend (A) and are measured according to quantitative ¹³C{¹H} NMR measurement.

In addition to C2 units and continuous C3 units the recycled low density polyethylene fraction (A) can further comprise units having 3, 4, 6 or 7 or more carbon atoms so that the recycled low density polyethylene fraction (A) can comprise ethylene units and a mix of units having 3, 4, 6 and 7 or more carbon atoms in total.

The recycled low density polyethylene fraction (A) preferably has one or more, more preferably all, of the following properties in any combination:
a melt flow rate (ISO 1133, 5.0 kg, 190° C.) of from 1.5 to 5.0 g/10 min, more preferably from 1.8 to 4.0 g/10 min; a melt flow rate (ISO 1133, 21.6 kg, 190° C.) of from 20.0 to 50.0 g/10 min, more preferably from 25.0 to 45.0 g/10 min;
a polydispersity index PI of from 1.0 to 3.5 s¹, more preferably from 1.2 to 3.0 s¹; determined as described below in the experimental section;
a complex viscosity at the frequency of 300 rad/s, eta₃₀₀, of from 500 to 750 Pa-s, more preferably from 550 to 700 Pa-s; determined as described below in the experimental section;
a complex viscosity at the frequency of 0.05 rad/s, eta_{0.05}, of from 15000 to 30000 Pa-s, more preferably from 16000 to 27500 Pa-s, determined as described below in the experimental section;
a Shore D hardness, measured after 3 s according to ISO 868, Shore D 3 s, of from 45 to 65, more preferably of from 48 to 60, determined as described below in the experimental section;
a xylene hot insoluble content, XHU, of from 0.01 to 1.0 wt.-%, more preferably from 0.1 to 0.5 wt.-%, determined as described below in the experimental section;
an ash content of from 0.01 to 2.5 wt.-%, more preferably of from 0.1 to 2.0 wt.-%,

It is preferred that the recycled low density polyethylene fraction (A) has a comparatively low gel content, preferably a gel content for gels with a size of from above 600 to 1000 μm of not more than 1200 gels/m², more preferably not more than 1000 gels/m². The lower limit of the gel content for gels with a size of from above 600 to 1000 μm is usually 20 gels/m², preferably 50 gels/m².

The recycled low density polyethylene fraction (A) preferably comprises a content of any of Co, Fe, Cu, Mo, Ti, and Zn, of not more than 400 ppm, more preferably not more than 350 ppm, even more preferably not more than 300 ppm, determined by x-ray fluorescence (XRF) as described in the experimental section below.

### Additives

The mixed-plastic recyclate polyethylene composition according to the present invention comprises at least one HALS UV stabilizer. The HALS UV stabilizer is preferably used in an amount of from 0.28 to 1.3 wt.-%, more preferably between 0.30 to 1.2 wt.-%, even more preferably from 0.35 to 1.2 wt.-%, based on the total weight of the mixed-plastic recyclate polyethylene composition.

Hindered amine light stabilizers (HALS) are chemical compounds containing an amine functional group that are used as stabilizers, details are published elsewhere, e.g. Zweifel, Hans; Maier, Ralph D.; Schiller, Michael (2009). Plastics additives handbook (6th ed.). Munich: Hanser. These compounds are typically 2,2,6,6-tetramethyl-piperidine derivatives containing at least one group of formula (I):

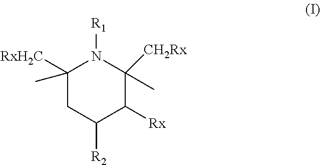

wherein R₁ and R₂ may be any suitable substituent independently selected from, for example, hydrogen, hydroxyl, linear or branched alkyl groups, linear or branched amine groups, linear or branched carboxylic acid groups, linear or branched ester groups and linear or branched ether groups and Rx may be hydrogen or methyl.

Examples and details of suitable HALS are published elsewhere, e.g. Zweifel, Hans; Maier, Ralph D.; Schiller, Michael (2009): Plastics additives handbook (6th ed.). Munich: Hanser.

Preferably, the HALS UV stabilizer is a compound derived from a substituted piperidine compound, in particular any compound which is derived from an alkyl-substituted piperidyl, piperidinyl or piperazinone compound or a substituted alkoxypiperidinyl compound. Preferably, the HALS UV stabilizer may be selected from the group consisting of bis-(2,2,6,6-tetramethyl-4-piperidyl)-sebacate (e.g. Sabostab® UV70), a mixture of esters of 2,2,6,6-tetramethyl-4-piperidinol and fatty acids (mainly from stearic acid) (e.g. Cyasorb® UV-3853), dimethyl succinate polymer with 4-hydroxy-2,2,6,6-tetramethyl-1-piperidine ethanol (e.g. Sabostab® UV62 microbeads), Poly((6-((1,1,3,3-tetramethylbutyl)amino)-1,3,5-triazine-2,4-diyl) (2,2,6,6-tetramethyl-4-piperidyl)imino)-1,6-hexanediyl ((2,2,6,6-tetramethyl-4-piperidyl)imino)) (e.g., Sabostab UV 94 from Sabo).

Normally, HALS additives are classified based on their molecular weight, namely, high molecular weight HALS when Mw>2000 g/mol and low molecular weight HALS if Mw is below 1000. Preferably, the at least one HALS additive used in the compositions of the invention is high molecular weight. A particularly preferred HALS UV stabilizer is Poly((6-((1,1,3,3-tetramethylbutyl)amino)-1,3,5-triazine-2,4-diyl) (2,2,6,6-tetramethyl-4-piperidyl)imino)-1,6-hexanediyl ((2,2,6,6-tetramethyl-4-piperidyl)imino)), commercially available from Sabo under the designation Sabostab® UV94.

The mixed-plastic recyclate polyethylene composition according to the present invention comprises at least one metal deactivator, which preferably excludes an alkyl hydroxyphenylalkanoyl hydrazine. Preferably, the metal deactivator is a compound derived from a substituted aromatic carboxylic acid ester compound, in particular any compound which is derived from an alkyl-substituted hydroxyphenyl carboxylic acid ester compound. A particularly preferred metal deactivator is (1,2-dioxoethylene)-bis(iminoethylene)-bis(3-(3,5-di-tert-butyl-4-hydroxyphenyl) propionate), commercially available from Palmarole under the designation Palmarole MDA. P. 11.

The metal deactivator is preferably used in an amount of from 0.05 to 0.50 wt.-%, more preferably from 0.06 to 0.45 wt.-%, even more preferably from 0.08 to 0.40 wt.-%, based on the total weight of the mixed-plastic recyclate polyethylene composition.

The mixed-plastic recyclate polyethylene composition according to the present invention may preferably comprise at least one phenolic antioxidant preferably in an amount of from 1000 to 3000 ppm, more preferably 1200 to 2500 ppm, based on the weight of the total composition.

The at least one phenolic antioxidant is preferably a sterically hindered phenolic antioxidant and may preferably be selected from the group consisting of 2,6-di-tert.butyl-4-methylphenol (e.g. Ionol® CP), [octadecyl 3-(3′,5′-di-tert. butyl-4-hydroxyphenyl)propionate] (e.g. Irganox® 1076), benzenepropanoic acid, 3,5-bis(1,1-dimethylethyl)-4-hydroxy-thiodi-2,1-ethanediyl ester (Irganox® 1035), [pentaerythrityl-tetrakis(3-(3′,5′-di-tert. butyl-4-hydroxyphenyl)-propionate)] (e.g. Irganox® 1010); 1,3,5-trimethyl-2,4,6-tris[(3,5-di-tert.butyl-4-hydroxyphenyl)]benzene (e.g. Irganox® 1330 (FF)), 1,3,5-tris(3′,5′-di-tert.butyl-4′-hydroxybenzyl)-isocyanurate (e.g. Irganox® 3114), bis-[3,3-bis-(4′-hydroxy-3′-tert.butylphenyl)butanic acid]-glycolester (e.g. Hostanox® O 3P), and 4,4′-Thiobis(2-tert. butyl-5-methylphenol) (Sumilizer WX-RC) or a combination thereof.

The mixed-plastic recyclate polyethylene composition according to the present invention may preferably comprise at least one phosphorous antioxidant preferably in an amount of from 400 to 1500 ppm, more preferably 500 to 1200 ppm, based on the weight of the total composition.

The at least one phosphorous antioxidant may preferably be selected from the group consisting of [bis(2-methyl-4,6-bis(1,1-dimethylethyl)phenyl)phosphorous acid ethylester] (e.g. Irgafos 38), [tris(2,4-di-t-butylphenyl)phosphite] (e.g. Irgafos® 168), tetrakis-(2,4-di-tert.butylphenyl)-4,4′-biphenylene-di-phosphonite (e.g. Hostanox® P-EPQ), di-stearyl-pentaerythrityl-diphosphite (e.g. ADK-STAB PEP-8T), bis-(2,4-dicumylphenyl)-pentaerythritol-diphosphite (e.g. Doverphos® S-9228), and [Phosphorous acid, cyclic butylethyl propandiol, 2,4,6-tri-t-butylphenyl ester] (e.g. Ultranox® 641).

### Virgin Polyethylene Components

The mixed-plastic recyclate polyethylene composition according to the present invention comprises a first virgin high density polyethylene component (B) and may optionally comprise a second virgin high density polyethylene component (C), optionally blended with carbon black.

The first virgin high density polyethylene component (B) may preferably comprise at least one bimodal polyethylene that may preferably comprise a polyethylene homopolymer and a polyethylene copolymer. The copolymer may be based on ethylene and 1-butene as comonomer. Preferably, the content of 1-butene in the polymer is in the range from 0.1 to 4 wt.-%, more preferably from 0.5 to 3.5 wt.-%, and even more preferably from 1.5 to 3.0 wt.-%, such as 2.5 wt.-%, based on the total weight of the polymer.

The first virgin high density polyethylene component (B) preferably has a melt flow rate (ISO 1133, 2.16 kg, 190° C.) of from 0.1 to 1.2 g/10 min, more preferably from 0.3 to 0.7 g/10 min, and a density of preferably from 940 to 970 kg/m³, more preferably from 942 to 962 kg/m³.

The second virgin high density polyethylene component (C) preferably has a melt flow rate (ISO 1133, 2.16 kg, 190° C.) of from 0.01 to 0.1 g/10 min, more preferably from 0.02 to 0.08 g/10 min, or preferably has a melt flow rate (ISO 1133, 5.0 kg, 190° C.) of from 0.05 to 1.0 g/10 min, more preferably from 0.1 to 0.5 g/10 min, and a density of preferably from 940 to 965 kg/m³, more preferably from 945 to 962 kg/m³.

The second virgin high density polyethylene component (C) may preferably comprise at least one bimodal polyethylene and may preferably comprise a polyethylene homopolymer and a polyethylene copolymer. The copolymer may be based on ethylene and 1-hexene as comonomer. Preferably, the content of 1-hexene in the polymer is in the range from 0.1 to 4 wt.-%, more preferably from 0.5 to 3 wt.-%, and even more preferably from 1.5 to 2.5 wt.-%, such as 2 wt.-%, based on the total weight of the polymer.

The second virgin high density polyethylene component (C) may have a melt flow rate MFR₅ (190° C., 5 kg, measured according to ISO 1133) in the range of 0.1 to 1 g/10 min, preferably of 0.15 to 0.5 g/10 min, more preferably of 0.2 to 0.3 g/10 min. The second virgin high density polyethylene component (C) may have a density of from 930 to 970 kg/m³, preferably 940-965 kg/cm³.

The resistance to slow crack growth SCG in a notched pipe test (9.2 bar, 80° C.) on SDR11 pipes having an outer diameter of 110 mm according to ISO 13479-2009 is at least 2.000 h, more preferably at least 5.000 h.

The first virgin high density polyethylene component (B) and/or the second virgin high density polyethylene component (C) may comprise carbon black or other pigments in an amount of not more than 5 wt.-%, preferably not more than 3 wt.-%. However, it is preferred that the first virgin high density polyethylene component (B) and/or the second virgin high density polyethylene component (C) do not comprise carbon black. It is further preferred that the first virgin high density polyethylene component (B) and/or the second virgin high density polyethylene component (C) do not comprise any pigments other than carbon black, more preferably comprise substantially no pigments.

The first virgin high density polyethylene component (B) and/or the second virgin high density polyethylene component (C) may preferably comprise a copolymer of ethylene and one or more comonomer units selected from alpha-olefins having from 3 to 6 carbon atoms. More preferably, they may comprise a copolymer of ethylene and 1-butene or a copolymer of ethylene and 1-hexene.

Apart from the above polymeric components, such as the recycled low density polyethylene fraction (A), the first virgin high density polyethylene component (B) and/or the second virgin high density polyethylene component (C), the mixed-plastic recyclate polyethylene composition of the present invention may further comprise additives in an amount of 10 wt.-% or below, more preferably 9 wt.-% or below, more preferably 7 wt.-% or below, based on the virgin high density polyethylene component. Suitable additives are, except for the specific additives indicated above, usual additives for utilization with polyolefins, such as stabilizers (e.g. antioxidant agents), metal scavengers and/or UV-stabilizers, antistatic agents and utilization agents (such as processing aid agents).

The first virgin high density polyethylene component (B) may preferably be present in the mixed-plastic recyclate polyethylene composition of the present invention in an amount of 55 wt.-% or less, preferably 45 wt.-% or less, more preferably 40 wt.-% or less. Preferably, first virgin high density polyethylene component (B) is present in the mixed-plastic recyclate polyethylene composition of the present invention in an amount of at least 15 wt.-%, more preferably at least 20 wt.-%, even more preferably at least 25 wt.-%. The content may preferably range from 15 to 50 wt.-%, more preferably from 20 to 50 wt.-%, even more preferably from 25 to 50 wt.-%, or from 27.5 to 60 wt.-%, still more preferably from 30 to 50 wt.-%, based on the overall weight of the composition.

If present, the second virgin high density polyethylene component (C) is preferably present in the mixed-plastic recyclate polyethylene composition of the present invention in an amount of from 1 to 20 wt.-%, more preferably from 2 to 18 wt.-%, still more preferably from 3 to 17 wt.-%, even more preferably from 4 to 16 wt.-% and still more preferably from 5 to 15 wt.-%, based on the overall weight of the composition.

The first virgin high density polyethylene component (B) and/or the second virgin high density polyethylene component (C) may preferably be bimodal polyethylenes. The properties and features of the virgin bimodal polyethylene that may be used in the mixed-plastic recyclate polyethylene composition of the present invention are described in the following.

The term “bimodal” means herein that the polymer consists of two polyethylene fractions, which have been produced under different polymerization conditions resulting in different (weight average) molecular weights and molecular weight distributions for the fractions. The form of the molecular weight distribution curve, i.e. the appearance of the graph of the polymer weight fraction as a function of its molecular weight, of a multimodal polymer will show two or more maxima or is typically distinctly broadened in comparison with the curves for the individual fractions.

The bimodal polyethylene preferably comprises a polyethylene homopolymer and a polyethylene copolymer.

By ethylene homopolymer is meant a polymer which is formed of essentially only ethylene monomer units, i.e. of 99.9 wt.-% ethylene or more. It will be appreciated that minor traces of other monomers may be present due to industrial ethylene containing trace amounts of other monomers.

The polyethylene copolymer is formed from ethylene with at least one other comonomer having at least 4 carbon atoms, e.g. C4-20 olefin. Preferred comonomers are alpha-olefins, especially with 4-8 carbon atoms. Preferably, the comonomer is selected from the group consisting of 1-butene, 1-hexene, 4-methyl-1-pentene, 1-octene, 1,7-octadiene and 7-methyl-1,6-octadiene. The use of 1-butene and 1-hexene is preferred.

Processes for obtaining such polymers are well known to a person skilled in the art and described for example in WO 2015/121161 A1.

### Method

The mixed-plastic recyclate polyethylene composition of the present invention may be prepared by a method comprising the step of melt mixing and extruding the recycled polyethylene fraction (A) in the presence of the at least one HALS UV stabilizer, and the at least one metal deactivator and in the presence of the first virgin high density polyethylene component (B) and optionally the second virgin high density polyethylene component (C) in an extruder. Optionally, the obtained mixed-plastic recyclate polyethylene composition may be pelletized in a twin screw extruder at a screw speed of not higher than 400 rpm and barrel temperature of not higher than 250° C.

### Articles

The present invention further relates to an article made from the mixed-plastic recyclate polyethylene composition according to the present invention, whereby said mixed-plastic recyclate polyethylene composition amounts to at least 85 wt.-%, preferably at least 90 wt.-%, more preferably at least 92 wt.-%, based on the total composition for making the article.

The article preferably is a jacketing material comprised in at least one layer of a power cable.

### Use

The present invention is further concerned with the use of the mixed-plastic recyclate polyethylene composition according to the present invention for wire and cable applications.

The mixed-plastic recyclate polyethylene composition according to the present invention, when used in wire or cable applications can substantially improve the mechanical and thermo-photo stability of a cable layer. It further can improve weather resistance and OIT properties of recycled polyethylene compositions.

### EXPERIMENTAL SECTION

### Methods

### a) Melt Flow Rate

Melt flow rates were measured with a load of 2.16 kg (MFR₂), 5.0 kg (MFR₅) or 21.6 kg (MFR₂₁) at 190° C. as indicated. The melt flow rate is that quantity of polymer in grams which the test apparatus standardized to ISO 1133 extrudes within 10 minutes at a temperature of or 190° C. under a load of 2.16 kg, 5.0 kg or 21.6 kg.

### b) Density

For determining the density of non-cellular plastics the ISO 1183-1:2012 standard immersion method is used (Archimedean principle). A specimen is weighed in air and immersed in a liquid (iso-dodecane), whose density is lower than that of the specimen. The value of this force is the same as that of the weight of the liquid displaced by the volume of the specimen.

This test is done on compression moulded plates of PE (polyethylene). For compression moulding process the following parameters are used:

| | | | Pressure | |
|---|---|---|---|---|
| | Time | Temperature | Hydraulic | Mould |
| PE | [s] | [° C.] | [bar] | [N/cm²] |
| Preheating | 360 | 180 | 5 | 7 |
| Moulding | 300 | 180 | 50 | 65 |
| | 300 | 180 | 200 | 262 |
| | 840 | 23 | | |

| | | | |
|---|---|---|---|
| Cooling | 15 K/min | 200 | 262 |

<40° C. demoulding temperature

Conditioning time: 24 h after compression moulding (PE)
Test temperature: 23° C.
Immersion liquid: Iso-dodecane
Buoyancy correction: no

### c) NMR Measurement

c-1) NMR Measurement of Virgin Polyethylene

Quantitative nuclear-magnetic resonance (NMR) spectroscopy was used to quantify the comonomer content of the virgin polymers.

Quantitative ¹³C{¹H} NMR spectra recorded in the molten-state using a Bruker Avance III 500 NMR spectrometer operating at 500.13 and 125.76 MHz for ¹H and ¹³C respectively. All spectra were recorded using a ¹³C optimised 7 mm magic-angle spinning (MAS) probe head at 150° C. using nitrogen gas for all pneumatics. Approximately 200 mg of material was packed into a 7 mm outer diameter zirconia MAS rotor and spun at 4 kHz. This setup was chosen primarily for the high sensitivity needed for rapid identification and accurate quantification (Klimke, K., Parkinson, M., Piel, C., Kaminsky, W., Spiess, H. W., Wilhelm, M., Macromol. Chem. Phys. 2006; 207:382., Parkinson, M., Klimke, K., Spiess, H. W., Wilhelm, M., Macromol. Chem. Phys. 2007; 208:2128., Castignolles, P., Graf, R., Parkinson, M., Wilhelm, M., Gaborieau, M., Polymer 50 (2009) 2373). Standard single-pulse excitation was employed utilising the transient NOE at short recycle delays of 3 s (Pollard, M., Klimke, K., Graf, R., Spiess, H. W., Wilhelm, M., Sperber, O., Piel, C., Kaminsky, W., Macromolecules 2004; 37:813., Klimke, K., Parkinson, M., Piel, C., Kaminsky, W., Spiess, H. W., Wilhelm, M., Macromol. Chem. Phys. 2006; 207:382.) and the RS-HEPT decoupling scheme (Filip, X., Tripon, C., Filip, C., J. Mag. Resn. 2005, 176, 239, Griffin, J. M., Tripon, C., Samoson, A., Filip, C., and Brown, S. P., Mag. Res. in Chem. 2007 45, S1, S198). A total of 1024 (1k) transients were acquired per spectrum.

Quantitative ¹³C{¹H} NMR spectra were processed, integrated and quantitative properties determined using custom spectral analysis automation programs. All chemical shifts are internally referenced to the bulk methylene signal (8) at 30.00 ppm (J. Randall, Macromol. Sci., Rev. Macromol. Chem. Phys. 1989, C29, 201).

Characteristic signals corresponding to the incorporation of 1-butene were observed (J. Randall, Macromol. Sci., Rev. Macromol. Chem. Phys. 1989, C29, 201.) and all contents calculated with respect to all other monomers present in the polymer with the limit of quantification being 0.2 mol % of butene.

Characteristic signals resulting from isolated 1-butene incorporation i.e. EEBEE comonomer sequences, were observed. Isolated 1-butene incorporation was quantified using the integral of the signal at 39.8 ppm assigned to the _{*}B2 sites, accounting for the number of reporting sites per comonomer:

$$B = {I}_{* B 2}$$

When characteristic signals resulting from consecutive 1-butene incorporation i.e. EBBE comonomer sequences were observed, such consecutive 1-butene incorporation was quantified using the integral of the signal at 39.3 ppm assigned to the ααB2B2 sites accounting for the number of reporting sites per comonomer:

$$BB = 2 * I {αα}_{B 2 B 2}$$

When characteristic signals resulting from non consecutive 1-butene incorporation i.e. EBEBE comonomer sequences were also observed, such non-consecutive 1-butene incorporation was quantified using the integral of the signal at 24.7 ppm assigned to the ββB2B2 sites accounting for the number of reporting sites per comonomer:

$$BEB = 2 * I {ββ}_{B 2 B 2}$$

Due to the overlap of the *B2 and *βB2B2 sites of isolated (EEBEE) and non-consecutively incorporated (EBEBE) 1-butene respectively the total amount of isolated 1-butene incorporation is corrected based on the amount of non-consecutive 1-butene present:

$$B = {I}_{B 2} - 2 * I {ββ}_{B 2 B 2}$$

With no other signals indicative of other comonomer sequences, i.e. butene chain initiation, observed the total 1-butene comonomer content was calculated based solely on the amount of isolated (EEBEE), consecutive (EBBE) and non-consecutive (EBEBE) 1-butene comonomer sequences:

$${B}_{total} = B + BB + BEB$$

Characteristic signals resulting from saturated end-groups were observed. The content of such saturated end-groups was quantified using the average of the integral of the signals at 22.8 and 32.2 ppm assigned to the 2s and 3s sites respectively:

$$S = ( 1 / 2 ) * ( {I}_{2 S} + {I}_{3 S} )$$

The relative content of ethylene was quantified using the integral of the bulk methylene (δ+) signals at 30.00 ppm:

$$E = ( 1 / 2 ) * I {δ}_{+}$$

The total ethylene comonomer content was calculated based the bulk methylene signals and accounting for ethylene units present in other observed comonomer sequences or end-groups:

$${E}_{total} = E + ( 5 / 2 ) * B + ( 7 / 2 ) * BB + ( 9 / 2 ) * BEB + ( 3 / 2 ) * S$$

The total mole fraction of 1-butene in the polymer was then calculated as:

$$fB = {B}_{total} / ( {E}_{total} + {B}_{total} )$$

The total comonomer incorporation of 1-butene in mole percent was calculated from the mole fraction in the usual manner:

$$B [ mol \% ] = 100 * fB$$

The total comonomer incorporation of 1-butene in weight percent was calculated from the mole fraction in the standard manner:

$$B [ wt \% ] = 100 * ( fB * 56.11 ) / ( ( fB * 56.11 ) + ( ( 1 - fB ) * 28.05 ) )$$

c-2) NMR Measurement of Recycled Polyethylene

Quantitative ¹³C{¹H} NMR spectra were recorded in the solution-state using a Bruker Avance III 400 MHz NMR spectrometer operating at 400.15 and 100.62 MHz for ¹H and ¹³C respectively. All spectra were recorded using a ¹³C optimised 10 mm extended temperature probe head at 125° C. using nitrogen gas for all pneumatics. Approximately 200 mg of material was dissolved in 3 ml of 1,2-tetrachloroethane-d₂ (TCE-d₂) along with chromium-(III)-acetylacetonate (Cr(acac)₃) resulting in a 65 mM solution of relaxation agent in solvent {singh09}. To ensure a homogenous solution, after initial sample preparation in a heat block, the NMR tube was further heated in a rotatory oven for at least 1 hour. Upon insertion into the magnet the tube was spun at 10 Hz. This setup was chosen primarily for the high resolution and quantitatively needed for accurate ethylene content quantification. Standard single-pulse excitation was employed without NOE, using an optimised tip angle, 1 s recycle delay and a bi-level WALTZ16 decoupling scheme {zhou07, busico07}. A total of 6144 (6k) transients were acquired per spectra.

Quantitative ¹³C{¹H} NMR spectra were processed, integrated and relevant quantitative properties determined from the integrals using proprietary computer programs. All chemical shifts were indirectly referenced to the central methylene group of the ethylene block (EEE) at 30.00 ppm using the chemical shift of the solvent. Characteristic signals corresponding to polyethylene with different short chain branches (B1, B2, B4, B5, B6plus) and polypropylene were observed {randall89, brandolini00}.

Characteristic signals corresponding to the presence of polyethylene containing isolated B1 branches (starB1 33.3 ppm), isolated B2 branches (starB2 39.8 ppm), isolated B4 branches (twoB4 23.4 ppm), isolated B5 branches (threeB5 32.8 ppm), all branches longer than 4 carbons (starB4plus 38.3 ppm) and the third carbon from a saturated aliphatic chain end (3 s 32.2 ppm) were observed. The intensity of the combined ethylene backbone methine carbons (ddg) containing the polyethylene backbone carbons (dd 30.0 ppm), γ-carbons (g 29.6 ppm) the 4s and the threeB4 carbon (to be compensated for later on) is taken between 30.9 ppm and 29.3 ppm excluding the Tββ from polypropylene. The amount of C2 related carbons was quantified using all mentioned signals according to the following equation:

$${fC}_{C 2 total} = ( Iddg - ItwoB 4 ) + ( IstarB 1 * 6 ) + ( IstarB 2 * 7 ) + ( ItwoB 4 * 9 ) + I ( threeB 5 * 10 ) + ( ( IstarB 4 plus - ItwoB 4 - IthreeB 5 ) * 7 ) + ( I 3 s * 3 )$$

Characteristic signals corresponding to the presence of polypropylene (PP, continuous C3)) were observed at 46.7 ppm, 29.0 ppm and 22.0 ppm. The amount of PP related carbons was quantified using the integral of Sαα at 46.6 ppm:

$${fC}_{PP} = Is αα * 3$$

The weight percent of the C2 fraction and the polypropylene can be quantified according following equations:

$${wt}_{C 2 fraction} = {fC}_{C 2 total} * 100 / ( {fC}_{C 2 total} + {fC}_{PP} )$$

$${wt}_{PP} = {fC}_{PP} * 100 / ( {fC}_{C 2 total} + {fC}_{PP} )$$

Characteristic signals corresponding to various short chain branches were observed and their weight percentages quantified as the related branch would be an alpha-olefin, starting by quantifying the weight fraction of each:

$$fwtC 2 = {fC}_{C 2 total} - ( ( IstarB 1 * 3 ) - ( IstarB 2 * 4 ) - ( ItwoB 4 * 6 ) - ( IthreeB 5 * 7 )$$

$$fwtC 3 ( isolated C 3 ) = IstarB 1 * 3$$

$$fwtC 4 = IstarB 2 * 4$$

$$fwtC 6 = ItwoB 4 * 6$$

$$fwtC 7 = IthreeB 5 * 7$$

Normalisation of all weight fractions leads to the amount of weight percent for all related branches:

$${fsum}_{wt \% total} = fwtC 2 + fwtC 3 + fwtC 4 + fwtC 6 + fwtC 7 + {fC}_{PP}$$

$$wtC 2 total = fwtC 2 * 100 / {fsum}_{wt \% total}$$

$$wtC 3 total = fwtC 3 * 100 / {fsum}_{wt \% total}$$

$$wtC 4 total = fwtC 4 * 100 / {fsum}_{wt \% total}$$

$$wtC 6 total = fwtC 6 * 100 / {fsum}_{wt \% total}$$

$$wtC 7 total = fwtC 7 * 100 / {fsum}_{wt \% total}$$

The content of LDPE can be estimated assuming the B5 branch, which only arises from ethylene being polymerised under high pressure process, being almost constant in LDPE. We found the average amount of B5 if quantified as C7 at 1.46 wt %. With this assumption it is possible to estimate the LDPE content within certain ranges (approximately between 20 wt % and 80 wt %), which are depending on the SNR ratio of the threeB5 signal:

$$wt \% LDPE = wtC 7 total * 100 / 1.46$$

### REFERENCES

zhou07 Zhou, Z., Kuemmerle, R., Qiu, X., Redwine, D., Cong, R., Taha, A., Baugh, D. Winniford, B., J. Mag. Reson. 187 (2007) 225
busico07 Busico, V., Carbonniere, P., Cipullo, R., Pellecchia, R., Severn, J., Talarico, G., Macromol. Rapid Commun. 2007, 28, 1128
singh09 Singh, G., Kothari, A., Gupta, V., Polymer Testing 28 5 (2009), 475
randall89 J. Randall, Macromol. Sci., Rev. Macromol. Chem. Phys. 1989, C29, 201.
brandolini00 A. J. Brandolini, D. D. Hills, NMR Spectra of Polymers and Polymer Additives, Marcel Dekker Inc., 2000

### d) Tensile Properties

The tensile properties were determined acc. ISO 527-2 on 5A ISO 527-2 dog bones in two laboratories (LA and LB). The dog bonds were die-cut (LA) or milled (LB) from compression moulded plaques of 2 mm thickness. The compression moulding was conducted with a melt temperature of 180° C. and a cooling rate of 15° C./min. For specimens tested in LA, a 0.5 mm/min test speed was used to measure the tensile modulus and 50 mm/min for all the other properties. For specimens tested in LB, 50 mm/min speed was also used to measure the modulus and all the other properties. All testing was performed at 23±2° C. and 50±10% humidity.

### e) Impact Strength (Charpy NIS)

The impact strength is determined as Charpy Notched Impact Strength according to ISO 179-1 eA at +23° C. on compression moulded specimens of 80×10×4 mm prepared according to ISO 17855-2.

### f) Metal Content

The content of metals was determined by x ray fluorescence (XRF).

The instrument used for the XRF measurements was a wavelength dispersive Zetium (2.4 kW) from Malvern Panalytical. The instrument was calibrated with polyolefin based standard sets from Malvern Panalytical i.e. Toxel (for Cu within range 0-25.1 ppm), and a custom set of calibration standards from Malvern Panalytical according to the following table for Ti and Zn

| Elements | range (ppm) |
|---|---|
| Ti | 0-273 |
| Zn | 0-576 |

Elements which are not covered by standards (Fe, Co, Mo), or the content is outside of the calibrated standard range, are then analysed with a semi-quantitative mode (software Omnian from Malvern Panalytical). The CH (carbon and hydrogen) content needed to run the semi-quantitative evaluation with Omnian was estimated by the software itself.

The analysis are done under vacuum on a plaque with a diameter of 40 mm and a thickness of 2 mm.

### g) Melting Temperature (Tm) and Crystallization Temperature (Tc) by DSC

A TA Instruments Q2000 Differential Scanning calorimeter calibrated with indium, zinc, and tin and operating under 50 mL/min of nitrogen flow was used. The employed thermal program consisted of a first heating step from 0 to 180° C. to erase the previous thermal history and a cooling step at 10° C./min. The melting behaviour was obtained by performing a second heating scan from 0 to 180° C. at 10° C./min. The crystallization and melting temperatures were taken as the peak values from the cooling and second heating scan respectively. The DSC trace was integrated from 30° C. to the end of the melting peak to evaluate the melting enthalpy (fusion heat).

### h) Dynamic Shear Measurements (Frequency Sweep Measurements)

The characterisation of melt of polymer composition or polymer as given above or below in the context by dynamic shear measurements complies with ISO standards 6721-1 and 6721-10. The measurements were performed on an Anton Paar MCR501 stress controlled rotational rheometer, equipped with a 25 mm parallel plate geometry. Measurements were undertaken on compression moulded plates, using nitrogen atmosphere and setting a strain within the linear viscoelastic regime. The oscillatory shear tests were done at 190° C. applying a frequency range between 0.01 and 600 rad/s and setting a gap of 1.3 mm.

In a dynamic shear experiment the probe is subjected to a homogeneous deformation at a sinusoidal varying shear strain or shear stress (strain and stress controlled mode, respectively). On a controlled strain experiment, the probe is subjected to a sinusoidal strain that can be expressed by

$$γ ( t ) = {γ}_{0} sin ( ω t ) \qquad ( 1 )$$

If the applied strain is within the linear viscoelastic regime, the resulting sinusoidal stress response can be given by

$$σ ( t ) = {σ}_{0} sin ( ω t + δ ) \qquad ( 2 )$$

where
σ₀ and γ₀ are the stress and strain amplitudes, respectively
ω is the angular frequency
δ is the phase shift (loss angle between applied strain and stress response)
t is the time

Dynamic test results are typically expressed by means of several different rheological functions, namely the shear storage modulus G′, the shear loss modulus, G″, the complex shear modulus, G*, the complex shear viscosity, η*, the dynamic shear viscosity, η′, the out-of-phase component of the complex shear viscosity η″ and the loss tangent, tan δ which can be expressed as follows:

$${G}^{′} = \frac{{σ}_{0}}{{γ}_{0}} cos δ [ Pa ] \qquad ( 3 )$$

$${G}^{″} = \frac{{σ}_{0}}{{γ}_{0}} sin δ [ Pa ] \qquad ( 4 )$$

$${G}^{*} = {G}^{′} + {iG}^{″} [ Pa ] \qquad ( 5 )$$

$${η}^{*} = {n}^{′} - i {η}^{″} [ Pa \cdot s ] \qquad ( 6 )$$

$${η}^{′} = \frac{{G}^{″}}{ω} [ Pa \cdot s ] \qquad ( 7 )$$

$${η}^{″} = \frac{{G}^{′}}{ω} [ Pa \cdot s ] \qquad ( 8 )$$

The determination of so-called Shear Thinning Index, which correlates with MWD and is independent of Mw, is done as described in equation 9.

$${SHI}_{( x / y )} = \frac{{Eta}^{*} for ( {G}^{*} = xkPa )}{{Eta}^{*} for ( {G}^{*} = ykPa )} \qquad ( 9 )$$

For example, the SHI_{(2.7/210)} is defined by the value of the complex viscosity, in Pa s, determined for a value of G* equal to 2.7 kPa, divided by the value of the complex viscosity, in Pa s, determined for a value of G* equal to 210 kPa.

The values of storage modulus (G′), loss modulus (G″), complex modulus (G*) and complex viscosity (η*) were obtained as a function of frequency (ω).

Thereby, e.g. η*_{300rad/s} (eta*_{300rad/s}) is used as abbreviation for the complex viscosity at the frequency of 300 rad/s and η*_{0.05rad/s} (eta*_{0.05rad/s}) is used as abbreviation for the complex viscosity at the frequency of 0.05 rad/s.

The loss tangent tan (delta) is defined as the ratio of the loss modulus (G″) and the storage modulus (G′) at a given frequency. Thereby, e.g. tan_{0.05} is used as abbreviation for the ratio of the loss modulus (G″) and the storage modulus (G′) at 0.05 rad/s and tan₃₀₀ is used as abbreviation for the ratio of the loss modulus (G″) and the storage modulus (G′) at 300 rad/s.

The elasticity balance tan_{0.05}/tan₃₀₀ is defined as the ratio of the loss tangent tan_{0.05} and the loss tangent tan₃₀₀.

Besides the above mentioned rheological functions one can also determine other rheological parameters such as the so-called elasticity index EI(x). The elasticity index EI(x) is the value of the storage modulus (G′) determined for a value of the loss modulus (G″) of x kPa and can be described by equation 10.

$$EI ( x ) = {G}^{′} for ( {G}^{″} = xkPa ) [ Pa ] \qquad ( 10 )$$

For example, the EI(5 kPa) is the defined by the value of the storage modulus (G′), determined for a value of G″ equal to 5 kPa.

The polydispersity index, PI, is defined by equation 11.

$$PI = \frac{{10}^{5}}{{G}^{′} ( {ω}_{COP} )} , {ω}_{COP} = ω for ( {G}^{′} = {G}^{″} ) \qquad ( 11 )$$

where ω_{COP} is the cross-over angular frequency, determined as the angular frequency for which the storage modulus, G′, equals the loss modulus, G″.

The values are determined by means of a single point interpolation procedure, as defined by Rheoplus software. In situations for which a given G* value is not experimentally reached, the value is determined by means of an extrapolation, using the same procedure as before. In both cases (interpolation or extrapolation), the option from Rheoplus “Interpolate y-values to x-values from parameter” and the “logarithmic interpolation type” were applied.

### REFERENCES

[1] Rheological characterization of polyethylene fractions” Heino, E. L., Lehtinen, A., Tanner J., Seppala, J., Neste Oy, Porvoo, Finland, Theor. Appl. Rheol., Proc. Int. Congr. Rheol, 11th (1992), 1, 360-362
[2] The influence of molecular structure on some rheological properties of polyethylene”, Heino, E. L., Borealis Polymers Oy, Porvoo, Finland, Annual Transactions of the Nordic Rheology Society, 1995.).
[3] Definition of terms relating to the non-ultimate mechanical properties of polymers, Pure & Appl. Chem., Vol. 70, No. 3, pp. 701-754, 1998.

### i) OIT Measurement

The oxidation induction time (OIT) at 200° C. was determined with a TA Instrument Q20 according to ISO11357-6. Calibration of the instrument was performed with indium (In) and tin (Sn), according to ISO 11357-1. The maximum error in temperature from calibration was less than 0.1 K. Each polymer sample (cylindrical geometry with a diameter of 5 mm and thickness of 1±0.1 mm) with a weight of 10±2 mg was placed in an open aluminium crucible, heated from 25° C. to 200° C. at a rate of 20° C. min⁻¹ in nitrogen (>99.95 vol. % N₂, <5 ppm O₂) with a gas flow rate of 50 mL min⁻¹, and allowed to rest for 5 min before the atmosphere was switched to pure oxygen (>99.95 vol. % O₂), also at a flow rate of 50 mL min⁻¹. The samples were maintained at constant temperature, and the exothermal heat associated with oxidation was recorded. The oxidation induction time was the time interval between the initiation of oxygen flow and the onset of the oxidative reaction. Each presented data point was the average of two independent measurements.

### j) Weather Resistance

The 5A ISO 527-2 dog bones were exposed to a xenon-arc lamp light following the standard ISO 4892-2 “Methods of exposure to laboratory light sources”, method a (humidification of the chamber air). The machine used for the conditioning was an Atlas-Ci5000 weatherometer, with the following conditions:

| | |
|---|---|
| Machine: | Atlas Ci5000 WEATHER-OMETER |
| Irradiance @ 300-400 nm: | 60 W/m² |
| Irradiance @ 340 nm: | 0.5 W/m² |
| Black standard temperature: | 65 +/− 2° C. |
| Air temperature | 38 +/− 3° C. |
| Relative humidity: | 70% |
| Rain cycle: | 102 min dry, followed by 18 min rain |

### k) Shore D Hardness

Shore D hardness is determined according to ISO 868 on compression moulded specimen with a thickness of 4 mm. The shore hardness is determined after 3 sec after the pressure foot is in firm contact with the test specimen.

### l) Ash Content

Thermogravimetric Analysis (TGA) experiments were performed with a Perkin Elmer TGA 8000. Approximately 10-20 mg of materials were placed in a platinum pan. The temperature was equilibrated at 50° C. for 10 minutes, and afterwards raised to 950° C. under nitrogen at 20° C./min. The ash content was evaluated as the weight % at 850° C.

### m) Gel Count (OCS)

The cast film samples have been produced and optically examined on a small-scale laboratory cast film line with installed camera detection from Optical Control Systems GmbH.

The line consists of an extruder with a Ø 25 mm screw with an L/D ration of 25. The extruder temperature profile has been set at from 170 to 210° C. for the five zones. The screw speed is 30 rpm. The extruder is followed by a die with a width of 150 mm and a fixed die gap of 0.5 mm. The film has been produced with a thickness of 70 μm. During the extrusion the chill-roll temperature has been set at 50° C. The gels and contaminations of the film have been detected and counted on 10 m² of the film during the extrusion process with transmitted light and a 4096 pixel camera. The resolution of the camera is 25 μm×25 on film. The gels and contaminations have been divided into 4 size-classes (100-299 μm; 300-599 μm; 600-1000 μm; >1000 μm).

### n) Xylene Insoluble Amount (XHU)

The xylene hot insoluble amount (XHU) is analysed according to ISO 10147. Therefore 1 g of the sample is weighed out exactly to 0.1 mg (m1) and placed in a pouch made of stainless steel mesh of the following material (“stainless steal quality 1.4401”). The pouch with polymer sample is weighed out exactly to 0.1 mg (m2), and placed in a round flask filled with 700 mL xylene (ortho- or para-xylene, with a purity chromatography >98%). The xylene is kept under reflux conditions for 5 h. The pouch containing the insoluble matter is taken out of the flask, washed from the polymer solution residues with a fresh portion of 700 mL xylene under reflux conditions for another 30 minutes. Afterwards the pouch is taken out of the flask, dried under vacuum at 90° C. to constant mass. After cooled to room temperature in a desiccator, the pouch is weighed out exactly to the nearest 0.1 mg (m3).

$$\% XHU = \frac{{m}_{3} - ( {m}_{2} - {m}_{1} )}{{m}_{1}} * 100$$

$$X H U = Xylene hot insoluble amount$$

$${m}_{1} = sample weight in g$$

$${m}_{2} = weight of pouch with the sample in g$$

$${m}_{3} = weight of pouch with the insoluble residue in g$$

By evaporating the xylene from the xylene solution the xylene hot soluble fraction is obtained.

### EXAMPLES

The following polymeric components were used in the following examples.

### Raw Materials

### 1) Virgin Polymers Used for Blending:

### Bimodal Polyethylene (PE-1)

PE1 is a natural bimodal high density polyethylene having a density of 946 kg/m³, a MFR₂ (ISO 1133, 190° C. under a load of 2.16 kg) of 0.5 g/10 min, a MFR₅ (ISO 1133,190° C. under a load of 5 kg) of 2 g/10 min and a MFR₂₁ (ISO 1133,190° C. under a load of 21.6 kg) of 36.35 g/10 min. Further properties are given in Table 1 below.

### Bimodal Polyethylene (PE-2)

PE2 is a natural bimodal high density polyethylene having a density of 949 kg/m³, a MFR₂ (ISO 1133,190° C. under a load of 2.16 kg) of 0.05 g/10 min, a MFR₅ (ISO 1133,190° C. under a load of 5 kg) of 0.23 g/10 min and a MFR₂₁ (ISO 1133, 190° C. under a load of 21.6 kg) of 9.48 g/10 min. Further properties are given in Table 1 below.

TABLE 1

| | PE1 | PE2 |
|---|---|---|
| Density (kg/m³) | 946 | 949 |
| MFR₂ (g/10 min, 190° C.) | 0.5 | 0.05 |
| MFR₂₁ (g/10 min, 190° C.) | 36.35 | 9.48 |
| MFR₅ (g/10 min, 190° C.) | 2 | 0.23 |
| eta*_{0.05rad/s} (Pa · s) | 21897 | 175270 |
| eta*_{300rad/s} (Pa · s) | 760 | 1281 |
| PI (1/Pa) | 1.9 | 2.68 |
| DSC_Fusion heat (J/g) | 173.2 | 191.3 |
| DSC_Tc (° C.) | 114.9 | 116.1 |
| DSC_Tm (° C.) | 128.6 | 130.9 |
| Impact strength 1eA +23 C (KJ/m²) | 14 | 42 |
| LB tensile modulus (MPa) | 885 | |
| LB strain at break (%) | 813.77 | |
| LB stress at break (MPa) | 31.62 | |

### 2). Recycled Low Density Polyethylene Fraction (A) Used for Blending:

The recycled polyethylene (rPE1) which is a recycled low density polyethylene fraction (A) is a mixture of low density and linear low density polyethylene (LDPE/LLDPE) and is commercially available from Ecoplast Kunststoffrecycling GmbH. The properties of rPE are given in Table 2 below. As rPE1 comes from a mechanical recycling process, the properties are indicated as averages based on analytical results of more than one batches.

TABLE 2

| | rPE1 |
|---|---|
| Density (kg/m³) | 930 |
| MFR₂ (g/10 min, 190° C.) | 0.8 |
| MFR₂₁ (g/10 min, 190° C.) | 35.2 |
| MFR₅ (g/10 min, 190° C.) | 2.6 |
| DSC_Fusion heat (J/g) | 106 |
| DSC_Tc (° C.) | 110 |
| DSC_Tm (° C.) | 123 |
| eta*_{0.05rad/s} (Pa · s) | 22000 |
| eta*_{300rad/s} (Pa · s) | 637 |
| PI (1/Pa) | 1.8 |
| XRF_Co (ppm) | n.d. |
| XRF_Fe (ppm) | 53 |
| XRF_Cu (ppm) | n.d. |
| XRF_Mo (ppm) | n.d. |
| XRF_Ti (ppm) | 168 |
| XRF_Zn (ppm) | 133 |
| NMR_C2 content (wt.-%) | 93 |
| NMR_PP content (wt.-%) | 1.7 |
| Shore D (3s) | 50 |
| XHU (wt.-%) | 0.3 |
| Ash content (wt.-%) | 0.4 |
| OCS_Gel_600-1000um (1/m2) | 425 |

### 3). Additives

TABLE 3

| | Additive | Chemical structure | Function |
|---|---|---|---|
| Add1 | CEASIT AV/T | 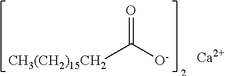 | Acid scavenger |
| Add2 | Irganox 1010 or KINOX 10 G | 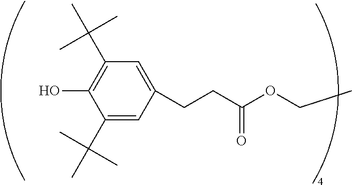 | Primary AO |
| Add3 | Irgafos 168 | 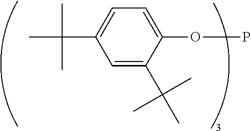 | Secondary AO |
| Add4 | Palmarole MDA. P.11 | 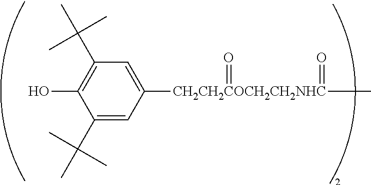 | Metal deactivator |
| Add5 | SABOSTAB UV 94 | 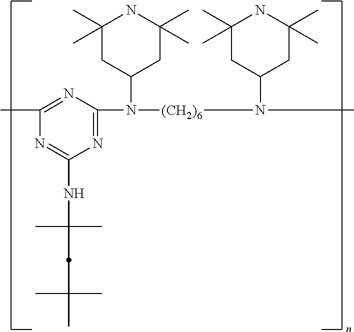 | HALS UV stabilizer |

The following inventive examples IE1 to IE4 as well as the comparative examples CE1 and CE2 were prepared via melt blending on a co-rotating twin screw extruder (ZSK) according to the following table. The polymer melt mixture was discharged and pelletized at a screw speed of 300 rpm. IE1 and CE1 were prepared using one batch of rPE1; whereas IE2, IE3, IE4 and CE2 were prepared using another batch. For strict comparison, data of IE1 shall be compared with CE1 and data of IE2, IE3, IE4 shall be compared with CE2.

The results are also shown in the following Table 4.

TABLE 4

| | IE1 | IE2 | IE3 | IE4 | CE1 | CE2 |
|---|---|---|---|---|---|---|
| rPE1 (wt.-%) | 50 | 50 | 50 | 50 | 50 | 50 |
| PE1 (wt.-%) | 39.31 | 39.31 | 38.65 | 38.45 | 39.41 | 39.56 |
| PE2 (wt.-%) | 10 | 10 | 10 | 10 | 10 | 10 |
| Add1 (wt.-%) | 0.05 | 0.05 | 0.05 | 0.05 | 0.05 | 0.04 |
| Add2 (wt.-%) | 0.16 | 0.16 | 0.16 | 0.16 | 0.16 | 0.11 |
| Add3 (wt.-%) | 0.05 | 0.05 | 0.05 | 0.05 | 0.05 | 0.04 |
| Add4 (wt.-%) | 0.1 | 0.1 | 0.1 | 0.3 | | |
| Add5 (wt.-%) | 0.33 | 0.33 | 0.99 | 0.99 | 0.33 | 0.25 |
| Density (kg/m³) | 939 | 939.1 | 939.3 | 939.6 | 938.9 | |
| MFR₂ (g/10 min, 190° C.) | 0.49 | 0.45 | 0.5 | 0.53 | 0.47 | 0.46 |
| MFR₂₁ (g/10 min, 190° C.) | 29.04 | 28.12 | 28.41 | 28.47 | 26.3 | 26.87 |
| MFR₅ (g/10 min, 190° C.) | 1.97 | 1.85 | 1.78 | 1.97 | 1.72 | 1.79 |
| OIT_200° C. (min) | 67.4 | 87.8 | 71 | 122.5 | 57.4 | 27.6 |
| LA strain at break (%) | 755.87 | | | | 763.67 | |
| LA stress at break (MPa) | 23.94 | | | | 24.36 | |
| LA FL 2000h_strain at break (%) | 585.65 | | | | 4.01 | |
| LA FL 2000h_stress at break (MPa) | 14.89 | | | | 12.57 | |
| LB tensile modulus (MPa) | | 619 | 626 | 627 | | 631 |
| LB strain at break (%) | | 618.57 | 656.73 | 720.62 | | 713.84 |
| LB stress at break (MPa) | | 17.49 | 18.68 | 21.5 | | 21.42 |
| LB FL 2000h_strain at break (%) | | 589.19 | 657.49 | 630.61 | | 46.4 |
| LB FL 2000h_stress at break (MPa) | | 14.47 | 16.64 | 16.67 | | 2.08 |
| Shore D (3s) | 57.3 | | | | 57.6 | |

LA: laboratory A;
LB: laboratory B

The above results show that adding a metal deactivator to the polyethylene composition comprising a recycled low density polyethylene fraction (A) and at least one virgin polyethylene component greatly increases OIT and effectively improves weather resistance and thermo-photo stability, while maintaining required mechanical properties, thus improving the performance of the compositions of the invention for outdoor applications.

1. A mixed-plastic recyclate polyethylene composition having a melt flow rate (ISO 1133, 2.16 kg, 190° C.) of from 0.1 to 1.2 g/10 min; and a density of from 930 to 955 kg/m³, and comprising
35 wt.-% or more of a recycled low density polyethylene fraction (A) having a crystallization temperature of not lower than 106° C.;
at least one HALS UV stabilizer;
at least one metal deactivator;
a first virgin high density polyethylene component (B) and optionally a second virgin high density polyethylene component (C), optionally blended with carbon black or other pigments,
wherein the mixed-plastic recyclate polyethylene composition has a tensile strain at break, determined according to ISO 527-1 on compression moulded ISO 527-2/5A specimens, after weather ageing of 2000 h according to EN ISO 4892-2 and as described herein, of at least 500%.

2. The mixed-plastic recyclate polyethylene composition according to claim 1, wherein the metal deactivator is not an alkyl hydroxyphenylalkanoyl hydrazine.

3. The mixed-plastic recyclate polyethylene composition according to claim 1, comprising the at least one metal deactivator in an amount of from 0.05 to 0.50 wt.-%, based on the weight of the total composition.

4. The mixed-plastic recyclate polyethylene composition according to claim 1, further comprising at least one phenolic antioxidant.

5. The mixed-plastic recyclate polyethylene composition according to claim 1, further comprising at least one phosphorous antioxidant.

6. The mixed-plastic recyclate polyethylene composition according to claim 1, comprising the at least one HALS UV stabilizer in an amount of from 0.28 to 1.3 wt.-%, based on the weight of the total composition.

7. The mixed-plastic recyclate polyethylene composition according to claim 1, wherein the recycled low density polyethylene fraction (A) comprises a content of any of Co, Fe, Cu, Mo, Ti, and Zn, of not more than 400 ppm, determined by x-ray fluorescence (XRF) as described herein.

8. The mixed-plastic recyclate polyethylene composition according to claim 1, wherein the first virgin high density polyethylene component (B) has a melt flow rate (ISO 1133, 2.16 kg, 190° C.) of from 0.1 to 1.2 g/10 min, and a density of from 940 to 970 kg/m³.

9. The mixed-plastic recyclate polyethylene composition according to claim 1, wherein the second virgin high density polyethylene component (C) has a melt flow rate (ISO 1133, 2.16 kg, 190° C.) of from 0.01 to 0.1 g/10 min, and a density of from 940 to 965 kg/m³.

10. The mixed-plastic recyclate polyethylene composition according to claim 1 having an oxidation induction time (OIT) at 200° C., determined as described herein of not less than 50 min.

11. A method of preparing the mixed-plastic recyclate polyethylene composition according to claim 1, comprising the step of melt mixing and extruding the recycled polyethylene fraction (A) in the presence of the at least one HALS UV stabilizer, and the at least one metal deactivator and in the presence of the first virgin high density polyethylene component (B) and optionally the second virgin high density polyethylene component (C) in an extruder.

12. Article made from the mixed-plastic recyclate polyethylene composition according to claim 1, whereby said mixed-plastic recyclate polyethylene composition amounts to at least 85 wt.-% of the total composition for making the article.

13. Article according to claim 12 being a jacketing material of a power cable.

14. A method, comprising extruding the mixed-plastic recyclate polyethylene composition according to claim 1 to form a layer of a wire or cable.

15. The mixed-plastic recyclate polyethylene composition according to claim 4, wherein the at least one phenolic antioxidant is present in an amount of from 1000 to 3000 ppm, based on the weight of the total composition.

16. The mixed-plastic recyclate polyethylene composition according to claim 5, wherein the at least one phosphorous antioxidant is present in an amount of from 400 to 1500 ppm, based on the weight of the total composition.
